(19) United States
(12) Patent Application Publication
(10) Pub. No.: US 2009/0152761 A1
(43) Pub. Date: Jun. 18, 2009

(54) Process for preparation of modified poly

(76) Inventor: Sam Louis Samuels, Landenberg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/001,539

(22) Filed: Dec. 12, 2007

(51) Int. Cl. B29C 47/78; C08G 63/02

(52) U.S. Cl. 264/211; 528/272

(57) ABSTRACT

An improved process is provided for making a shaped article of a modified poly(trimethylene terephthalate) polymer wherein the intrinsic viscosity of the modified poly(trimethylene terephthalate) present in the shaped article is at least 95% that of the intrinsic viscosity of the poly(trimethylene terephthalate) prior to modification.

### FIELD OF THE INVENTION

The present invention relates to an improved process for making an article of poly(trimethylene terephthalate).

### BACKGROUND OF THE INVENTION

Poly(trimethylene terephthalate) (3GT or PTT) is a synthetic resin that is suited for use in many materials and products that are currently manufactured from polyesters, for example films, carpet fibers, textile fibers, miscellaneous industrial fibers, containers, and packaging. The polymer, which is abbreviated as 3GT herein, is also referred to in the art as poly(propylene terephthalate) (PPT). A synthetic method for preparation of 3GT is disclosed in British Patent No. 587,097, granted in 1941.

When used to prepare packaging articles, the 3GT polymer is typically melt processed to form a 3GT film or sheet. The resultant film or sheet can then be thermoformed or otherwise converted into a desired packaging article. Because of thermal and/or shear conditions that exist during the melt process, for example in process steps that involve extrusion of the polymer melt, degradation of the 3GT polymer can occur, resulting in a reduction in molecular weight of the 3GT polymer. Such a molecular weight decrease can affect certain physical properties. As an example, polymer viscosity may be reduced, which renders the resulting 3GT film or sheet less suitable for manufacture of packaging articles.

It would be desirable to have available a simple melt processing method for 3GT polymer, wherein the molecular weight, as indicated by intrinsic viscosity (I.V.), of the polymer in the resulting product is not reduced to any significant extent as a result of conditions present during the process.

### SUMMARY OF INVENTION

The present invention is directed to a process for preparing a shaped article from a composition comprising a modified 3GT polymer, the process comprising the steps of
(A) mixing a poly(trimethylene terephthalate) polymer and a chain extender to form a polymer composition;
(B) subsequent to or simultaneous with step (A), heating the polymer composition to form a polymer melt comprising a modified poly(trimethylene terephthalate) polymer; and
(C) passing the polymer melt through a die orifice, thereby producing a shaped article comprising the modified poly(trimethylene terephthalate) polymer, wherein the modified poly(trimethylene terephthalate) polymer present in the composition comprising the shaped article has an intrinsic viscosity, as measured according to Goodyear R-103B Equivalent IV Method, of at least 95% that of the intrinsic viscosity of the poly(trimethylene terephthalate) polymer prior to being mixed with the chain extender.

In a preferred embodiment steps (B) and (C) of the process are carried out in an extruder.

The invention is further directed to a composition comprising a 3GT polymer and about 0.1 to about 1 wt % of a chain extender, based on the combined weight of the 3GT polymer and the chain extender.

### DETAILED DESCRIPTION OF THE INVENTION

The present invention provides an improved melt process for preparing a shaped article (e.g., a film or a sheet) from a polymer melt comprising a modified 3GT polymer. The process involves the use of a multi-functional chain extender wherein the multi-functional chain extender is mixed with a 3GT polymer prior to or simultaneously with the formation of the polymer melt. The intrinsic viscosity of the modified 3GT polymer present in the resultant shaped article either exceeds or is maintained at a level close to the intrinsic viscosity of the 3GT polymer prior to contact with, i.e. prior to being mixed with, the chain extender.

3GT is a polyester prepared by the condensation polymerization of 1,3-propanediol and terephthalic acid. It may also be prepared by the polymerization of a resin that results from a, reaction of 1,3-propanediol with a diester of terephthalic acid. 3GT and methods for manufacturing 3GT are known and are described in, e.g., U.S. Pat. Nos. 5,015,789; 5,276,201; 5,284,979; 5,334,778; 5,364,984; 5,364,987; 5,391,263; 5,434,239; 5,510,454; 5,504,122; 5,532,333; 5,532,404; 5,540,868; 5,633,018; 5,633,362; 5,677,415; 5,686,276; 5,710,315; 5,714,262; 5,730,913; 5,763,104; 5,774,074; 5,786,443; 5,811,496; 5,821,092; 5,830,982; 5,840,957; 5,856,423; 5,962,745; 5,990,265; 6,235,948; 6,245,844; 6,255,442; 6,277,289; 6,281,325; 6,312,805; 6,325,945; 6,331,264; 6,335,421; 6,350,895; 6,353,062; and 6,538,076, European Patent No. 998 440, PCT Patent Application Nos. WO 00/14041 and WO 98/57913, H. L. Traub, “Synthese und textilchemische Eigenschaften des Poly-Trimethyleneterephthalats”, Dissertation Universitat Stuttgart (1994), and S. Schauhoff, “New Developments in the Production of 3GT (PTT)”, Man-Made Fiber Year Book (September 1996). 3GT is also commercially available from E.I. du Pont de Nemours and Company, Wilmington, Del. (DuPont), under the trade name Sorona® polymer (DuPont™ Applied Biomaterials), Sorona® EP thermoplastic resins (DuPont™ Engineering Plastics) and Biomax® RS PTT packaging resins (DuPont™ Packaging and Industrial Polymers).

3GT polymers useful in the practice of the invention may be homopolymers or copolymers containing at least about 70 mol % of copolymerized monomer units of trimethylene terephthalate. In addition, the 3GT polymer may be a component of a polymer blend. The polymer blend may comprise, for example, at least about 25 wt %, at least about 40 wt %, at least about 75 wt %, or at least about 90 wt % of 3GT homopolymers or copolymers, based on the total weight of the blend composition.

Preferred 3GT copolymers typically contain at least about 85 mol %, more preferably at least about 90 mol %, yet more preferably at least about 95 mol %, and most preferably at least about 98 mol %, of copolymerized units of trimethylene terephthalate.

Examples of 3GT copolymers include copolyesters synthesized from 3 or more reactants, each having two ester forming groups. For example, a 3GT copolymer (co3GT) can be prepared by reacting 1,3-propanediol, terephthalic acid, and one or more comonomers selected from linear, cyclic, and branched aliphatic dicarboxylic acids having 4-12 carbon atoms (such as butanedioic acid, pentanedioic acid, hexanedioic acid, dodecanedioic acid, and 1,4-cyclohexanedicarboxylic acid); aromatic dicarboxylic acids (other than terephthalic acid) having 8-12 carbon atoms (such as isophthalic acid and 2,6-naphthalenedicarboxylic acid); linear, cyclic, and branched aliphatic diols (other than 1,3-propanediol) having 2-8 carbon atoms (such as ethanediol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and aliphatic and aromatic ether glycols having 4-10 carbon atoms (such as hydroquinone bis(2-hydroxyethyl)ether). Alternatively, a co3GT can be prepared from a poly(ethylene ether) glycol having a molecular weight below about 460, such as diethylene ether glycol. The comonomer typically is present in the copolymer at a level of about 0.5 to about 15 mol %, and may be present at a level of up to about 30 mol %.

The 3GT copolymer may comprise other comonomers that do not have a significant adverse effect on the polymer properties. Such comonomers may be copolymerized into the copolymer chain in minor amounts, e.g., up to about 10 mol %, or up to about 5 mol %. Examples of such other comonomers include functional comonomers such as 5-sodium sulfoisophthalate, which is preferably used in an amount of about 0.2 to about 5 mol %. Very small amounts, about 5 mol % or less, or preferably about 2 mol % or less, of trifunctional comonomers, such as trimellitic acid, may also be incorporated into the copolymer for the purpose of viscosity control.

When the 3GT polymer is a component of a polymer blend, the blend can be prepared by mixing a 3GT homopolymer or copolymer with one or more other polymers. Preferably, the 3GT polymer blend contains up to about 75 wt % of one or more of the other polymers, based on the total weight of the blend. Examples of other polymers suitable for blending with a 3GT homopolymer or copolymer are polyesters prepared from other diols, such as the diols described above.

The 3GT polymer resin suitable for use in the process of the invention may further contain suitable additives to improve strength, facilitate post melting processing, or provide other benefits. For example, hexamethylene diamine and/or polyamides (e.g., as nylon 6 or nylon 6-6) may be added in minor amounts of about 0.5 to about 5 mol % to improve processability. These polymeric additives may be added to compositions wherein 3GT polymers and/or copolymers are the only other polymeric material. The polymeric additives may also be useful in blends of 3GT polymers and/or copolymers with other polymeric materials. A nucleating agent, preferably about 0.005 to about 2 wt % of a monosodium salt of a dicarboxylic acid selected from monosodium terephthalates, monosodium naphthalene dicarboxylates, and monosodium isophthalates, can be added as disclosed in U.S. Pat. No. 6,245,844.

The 3GT polymer resins may, if desired, contain other additives, e.g., delusterants, nucleating agents, heat stabilizers, viscosity boosters, optical brighteners, pigments, and antioxidants. Additives suitable for use in the process of the invention are disclosed in, e.g., U.S. Pat. Nos. 3,671,379; 5,798,433; and 5,340,909, European Patent Nos. 699 700 and 847 960, and PCT Patent Application No. WO 00/26301.

The 3GT polymer suitable for use in the process of the invention preferably has an intrinsic viscosity ranging from about 0.8 dl/g to about 1.4 dl/g, or about 0.9 dl/g to about 1.1 dl/g (as measured using Goodyear R-103B Equivalent IV Method at a concentration of 0.4 g/dL in 50/50 wt % trifluoroacetic acid/dichloromethane) and a number average molecular weight (Mₙ) ranging from about 15,000 to about 45,000, or about 25,000 to about 30,000.

The “chain extenders” or “chain extending compounds” useful in the practice of the invention are multi-functional reactive materials and may include any multi-functional materials which can be reacted with the carboxyl and/or hydroxyl end groups of the 3GT polymer to extend the polymer chains and thereby increase the molecular weight and viscosity of the polymer, i.e. the chain extenders modify the 3GT polymers by chemically reacting with the carboxyl and/or hydroxyl groups of the 3GT polymer. Examples of suitable chain extenders include epoxy-functionalized styrene acrylic copolymers and epoxy-functionalized styrene methacrylic copolymers and mixtures thereof, such as those commercially available from Clariant Corporation, Charlotte, N.C., under the trade names CESA® Extend 1598, 1795, and 9930; or from Ciba Specialty Chemicals, Inc., Tarrytown, N.J., under the trade name IRGAMOD® RA20; or from BASF, Florham Park, N.J., under the trade names JONCRYL® ADR-4368 and 4370. Other suitable chain extenders include, but are not limited to, pyromellitic dianhydride, phenylenebisoxazoline, carbonyl bis(1-caprolactam), diepoxides (e.g., reaction products of bisphenol A and diglycidyl ether) and tetraepoxides (e.g., tetraglycidyl diaminodiphenylmethane).

The melt process of the invention comprises the steps of mixing the 3GT polymer or polymer blend of which the 3GT polymer is a component and the chain extender to form a polymer composition, heating the polymer composition to form a polymer melt that comprises a modified 3GT polymer and passing the polymer melt through a suitably shaped die orifice to produce the desired shaped article. The heating step is often carried out in processing equipment such as an extruder, within which the temperature is set to the melting point of the polymer composition or above. In the practice of the present invention, the polymer composition may be heated to a temperature of at least about 230° C., or preferably about 230° C. to about 270° C., or more preferably about 235° C. to about 260° C. Additionally, adequate mixing may be applied during the heating step to assure uniformity of the polymer melt. Different types of dies may be used to produce various kinds of shaped articles, such as sheets and strips (slot dies) and hollow and solid sections (circular dies). In this manner, sheets of different widths and thickness may be produced and the polymeric sheets exiting from the dies may be taken up on rollers or as flat sheets, cooled and removed by means of suitable devices which are designed to prevent any subsequent deformation of the sheets. Any of a variety of extruders or specialized melt kneaders (e.g., Buss Kneaders) and mixers (e.g., Brabender Mixers or Haake Mixers) may be used in the melt process of the invention. Preferably, the melt process is carried out in an extruder in which the extruding force may be exerted by a rotating screw (screw extrusion). Any suitable type of extruder, such as a single-screw, a twin-screw, or a multi-screw extruder may be used in the practice of the invention.

Because the 3GT polymer is maintained under high temperature conditions during formation of the polymer melt and delivery of the melt through the die, the polymer chains of the 3GT polymers are degraded to some extent, which results in a reduction in molecular weight and viscosity. When no chain extender is added, depending on the particular starting material and the process conditions, the intrinsic viscosity of the poly(trimethylene terephthalate) polymer in the resulting shaped product may be reduced up to about 10% compared to the intrinsic viscosity of the 3GT polymer prior to the melt process. This is particularly the case when the process is carried out using an extruder.

As a result of the addition of the chain extenders to the 3GT polymer composition prior to or during the formation of the polymer melt it is possible to maintain the intrinsic viscosity of the modified 3GT polymer present in the composition that exits the die orifice at a level substantially the same as that of the unmodified 3GT polymer prior to mixing with the chain extender. By “substantially the same”, it is meant that the intrinsic viscosity of the modified 3GT polymer present in the composition exiting the die according to the process of the invention, as measured according to Goodyear R-103B Equivalent IV Method, is at least about 95%, preferably at least about 98% of the intrinsic viscosity of the unmodified 3GT polymer prior to contact with the chain extender. By “unmodified 3GT polymer” is meant the 3GT polymer that is not mixed or contacted with the chain extender. “Modified” as used herein means that chemical reaction has taken place between the 3GT polymer and the chain extender.

In other embodiments of the process of the invention, the intrinsic viscosity of the modified 3GT polymer present in the composition as it exits the die (i.e. the modified 3GT polymer) will be increased relative to that of the unmodified 3GT polymer prior to contact or mixing with the chain extender. Preferably, such examples of the process of the invention will be carried out in an extruder.

Without being bound to any particular theory, it is believed that during the process of the invention, although the high temperature conditions cause degradation of some of the polymer chains, the presence of the chain extenders causes the extension of some fraction of the polymer chains by reacting with the carboxyl and/or hydroxyl end groups of the 3GT polymers, thereby maintaining the intrinsic viscosity of the modified poly(trimethylene terephthalate) polymer in the resulting composition at a desirable level.

In the practice of the invention, chain extender may be mixed with the unmodified 3GT polymer prior to subjecting the composition to the heating step, for example in a pre-mixing step performed prior to introduction of the mixture to the processing equipment in which the polymer melt is formed. Alternatively, the chain extender and the unmodified 3GT polymer may be added separately to the processing equipment in which the polymer melt is formed, for example through separate ports. The addition may be made prior to or simultaneously with the heating step that forms the polymer melt. It is preferred that an effective amount of the chain extender is mixed with the 3GT polymer to form a masterbatch prior to the heating step. Preferably, the resultant masterbatch is then introduced to an extruder maintained at a temperature sufficient to form a polymer melt.

By “an effective amount” is meant the amount of a particular chain extender or mixture of chain extenders that can be mixed with a 3GT polymer to form a shaped 3GT article, wherein the intrinsic viscosity of the modified 3GT polymer present in the resulting shaped 3GT article is substantially the same as or exceeds that the intrinsic viscosity of the unmodified 3GT polymer. The appropriate amount of chain extender that constitutes an effective amount can be determined by a skilled artisan based on the intrinsic viscosity of the starting unmodified 3GT polymer, the desired intrinsic viscosity of the modified poly(trimethylene terephthalate) polymer present in the resulting shaped 3GT article, and the particular chain extender(s) that are selected for use. In general, it is preferred that about 0.1 to about 1 wt %, or preferably about 0.3 to about 0.8 wt %, or more preferably about 0.4 to about 0.6 wt %, of a chain extender, based on the combined weight of the 3GT polymer and the chain extender, is used.

### EXAMPLES

### Materials

3GT: Sorona® polymer, a poly(trimethylene terephthalate) available from E.I. du Pont de Nemours and Company, Wilmington, Del.;
CE-A: Joncryl® ADR-4368, a multi-functional styrene-acrylic oligomer chain extender available from BASF, Florham Park, N.J.;
CE-B: CESA® Extend 9930, a poly(ethylene terephthalate) masterbatch containing 30 wt % of a multi-functional styrene-acrylic oligomer chain extender, available from Clariant Corporation, Charlotte, N.C.; and
CE-C: CESA® Extend 1795, a polypropylene masterbatch containing 30% of a multi-functional styrene-acrylic oligomer chain extender, available from Clariant Corporation, Charlotte, N.C.

### Extrusion Process

3GT pellets, alone or in combination with a chain extender (i.e., CE-A, CE-B, or CE-C) at various concentrations were fed into a Werner-Pfleiderer twin-screw extruder equipped with a 10 inch (25 cm) slot die with a 20 mil (0.51 mm) gap. The extruder was operated at a temperature of 240° C. and a screw speed of 150 rpm. Films having a thickness of about 10 mils (0.25 mm) were collected at a speed of about 3 feet/min (0.9 m/min).

### Intrinsic Viscosity and Melt Viscosity

The intrinsic viscosity of the 3GT pellets and the films obtained from the extrusion process were measured at a concentration of 0.4 g/dL in 50/50 wt % trifluoroacetic acid/dichloromethane, in accordance with Goodyear R-103B Equivalent IV Method. Melt viscosity was measured at 260° C. in a capillary rheometer. Results are tabulated in Table 1.

### Results

As shown in Table 1, Comparative Example 1 (CE1), the starting 3GT polymer, had an intrinsic viscosity of 1.126 dl/g. The data indicate that following extrusion of the 3GT polymer into a film (Comparative Examples 2-4) in the absence of a chain extender the intrinsic viscosity decreased by 7-10%. When a chain extender was fed to the extruder along with the 3GT polymer pellets, the intrinsic viscosity of the resulting extruded film compositions was substantially equivalent to (Example 1) or exceeded (Examples 2-6) that of Comparative Example 1.

TABLE 1

| | | Active Amount | | | Melt | Melt |
|---|---|---|---|---|---|---|
| | | Chain | | Intrinsic | Viscosity | Viscosity |
| Example | | Extender | | Viscosity | (Pa-s at | (Pa-s at |
| Number | Composition | (wt %) | Form | (dl/g) | 100.2 s⁻¹) | 1002 s⁻¹) |
| CE1 | 3GT | — | Pellets* | 1.126 | 249 | 172 |
| CE2 | 3GT | — | Film** | 1.008 | 33 | 33 |
| CE3 | 3GT | — | Film** | 1.019 | 157 | 108 |
| CE4 | 3GT | — | Film** | 1.048 | 69 | 63 |
| E1 | 3GT/CE-A | 0.1 | Film** | 1.09 | 139 | 94 |
| E2 | 3GT/CE-B | 0.3 | Film** | 1.134 | 219 | 148 |
| E3 | 3GT/CE-C | 0.3 | Film** | 1.143 | 233 | 142 |
| E4 | 3GT/CE-A | 0.5 | Film** | 1.129 | 132 | 97 |
| E5 | 3GT/CE-B | 0.6 | Film** | 1.152 | 280 | 157 |
| E6 | 3GT/CE-C | 0.6 | Film** | 1.163 | 275 | 145 |

*The intrinsic viscosity and melt viscosity for Comparative Example 1 were measured using 3GT pellets;
**The intrinsic viscosity and melt viscosity for Comparative Examples 2-4 and Examples 1-6 were measured using the films prepared with Werner-Pfleiderer extruders.

What is claimed is:

1. A process for preparing a shaped article from a composition comprising a modified poly(trimethylene terephthalate) polymer, the process comprising the steps of
(a) mixing a poly(trimethylene terephthalate) polymer and a chain extender to form a polymer composition;
(b) subsequent to or simultaneous with step (a), heating the polymer composition to form a polymer melt comprising a modified poly(trimethylene terephthalate) polymer; and
(c) passing the polymer melt through a die orifice, thereby producing a shaped article comprising the modified poly(trimethylene terephthalate) polymer, wherein the modified poly(trimethylene terephthalate) polymer present in the composition comprising the shaped article has an intrinsic viscosity, as measured according to Goodyear R-103B Equivalent IV Method, of at least 95% of the intrinsic viscosity of the poly(trimethylene terephthalate) polymer prior to being mixed with the chain extender.

2. The process of claim 1, wherein the poly(trimethylene terephthalate) polymer is selected from the group consisting of trimethylene terephthalate homopolymers, trimethylene terephthalate copolymers comprising at least about 70 mol % of copolymerized monomer units of trimethylene terephthalate, polymer blends comprising at least about 25 wt % of trimethylene terephthalate homopolymers and polymer blends comprising at least about 25 wt % of trimethylene terephthalate copolymers.

3. The process of claim 1, wherein the poly(trimethylene terephthalate) polymer has an intrinsic viscosity of about 0.8 to about 1.4 dl/g prior to mixing with the chain extender.

4. The process of claim 3, wherein the poly(trimethylene terephthalate) polymer has an intrinsic viscosity of about 0.9 to about 1.1 dl/g prior to mixing with the chain extender.

5. The process of claim 1, wherein the modified poly(trimethylene terephthalate) polymer present in the composition comprising the shaped article has an intrinsic viscosity of at least 98% that of the poly(trimethylene terephthalate) polymer prior to being mixed with the chain extender.

6. The process of claim 5, wherein the modified poly(trimethylene terephthalate) polymer present in the composition comprising the shaped article has an intrinsic viscosity equal to or exceeding that of the poly(trimethylene terephthalate) polymer prior to being mixed with the chain extender.

7. The process of claim 1, wherein the chain extender is a multi-functional reactive material.

8. The process of claim 7, wherein the chain extender is selected from the group consisting of epoxy-functionalized styrene methacrylic copolymers, epoxy-functionalized styrene acrylic copolymers, pyromellitic dianhydrides, phenylenebisoxazolines, carbonyl bis(1-caprolactam)s, diepoxides, tetraepoxides, and mixtures of two or more thereof.

9. The process of claim 8, wherein the chain extender is a polymer selected from the group consisting of epoxy-functionalized styrene methacrylic copolymers, epoxy-functionalized styrene acrylic copolymers and mixtures thereof.

10. The process of claim 1, wherein the polymer composition comprises about 0.1 to about 1 wt % of the chain extender, based on the combined weight of the poly(trimethylene terephthalate) polymer and chain extender.

11. The process of claim 10, wherein the polymer composition comprises about 0.3 to about 0.8 wt % of the chain extender, based on the combined weight of the poly(trimethylene terephthalate) polymer and chain extender.

12. The process of claim 1, wherein the shaped article is a film or sheet.

13. The process of claim 1, wherein the mixing step (a) is carried out prior to the heating step (b).

14. The process of claim 1, wherein the mixing step (a) is carried out simultaneously with the heating step (b).

15. The process of claim 1, wherein the polymer melt is formed in an extruder.

16. The process of claim 15, wherein the polymer composition comprising the poly(trimethylene terephthalate) and the chain extender is mixed prior to introduction to the extruder.

17. A composition comprising a poly(trimethylene terephthalate) polymer and about 0.1 to about 1 wt % of a chain extender, based on the combined weight of the poly(trimethylene terephthalate) polymer and chain extender.

18. The composition of claim 17, wherein the poly(trimethylene terephthalate) polymer is selected from the group consisting of trimethylene terephthalate homopolymers, trimethylene terephthalate copolymers comprising at least about 70 mol % of copolymerized monomer units of trimethylene terephthalate, polymer blends comprising at least about 70 mol % of the trimethylene terephthalate homopolymers and polymer blends comprising at least about 25 wt % of trimethylene terephthalate copolymers.

19. The composition of claim 17, wherein the poly(trimethylene terephthalate) polymer has an intrinsic viscosity of about 0.5 to about 1.4 dl/g.

20. The composition of claim 17, wherein the poly(trimethylene terephthalate) polymer has an intrinsic viscosity of about 0.9 to about 1.1 dl/g.

21. The composition of claim 17, comprising about 0.3 to about 0.8 wt % of the chain extender.

22. The composition of claim 17, wherein the chain extender is a multi-functional reactive material.

23. The composition of claim 22, wherein the chain extender is selected from the group consisting of epoxy-functionalized styrene methacrylic copolymers, epoxy-functionalized styrene acrylic copolymers, pyromellitic dianhydrides, phenylenebisoxazolines, carbonyl bis(1-caprolactam)s, diepoxides, tetraepoxides, and mixtures of two or more thereof.

24. The composition of claim 23, wherein the chain extender is selected from the group consisting of epoxy-functionalized styrene methacrylic copolymers, epoxy-functionaized styrene acrylic copolymers and mixtures thereof.
